(19) United States
(12) Patent Application Publication
(10) Pub. No.: US 2024/0103766 A1
(43) Pub. Date: Mar. 28, 2024

(54) METHOD, ELECTRONIC DEVICE, AND COMPUTER PROGAM PRODUCT FOR ASYNCHRONOUSLY ACCESSING DATA

(71) Applicant: DELL PRODUCTS L.P., ROUND ROCK, TX (US)

(72) Inventors: Tao Chen, Beijing (CN); Ran Liu, Beijing (CN); Wensi Zhao, Beijing (CN)

(21) Appl. No.: 17/987,156

(22) Filed: Nov. 15, 2022

(30) Foreign Application Priority Data
Sep. 23, 2022 (CN) 202211167211.5

(51) Int. Cl. G06F 3/06

(52) U.S. Cl. CPC G06F 3/0659; G06F 3/0604; G06F 3/0634; G06F 3/067

(57) ABSTRACT

Embodiments of the present disclosure provide a method, an electronic device, and a computer program product for asynchronously accessing data. The method may include determining, on the basis of an instruction of a user, data to be moved in a persistent memory and metadata associated with the data. The method may further include sending the metadata to a programmable network device associated with the persistent memory such that the programmable network device moves the data on the basis of the metadata. In addition, the method may include informing, in response to receiving a confirmation of operation completion from the programmable network device, the user that the operation of moving the data has been completed. The embodiments of the present disclosure can achieve an operation of asynchronously accessing data. Furthermore, computing resources of a central processing unit (CPU) are saved, so that the user experience is enhanced.

### TECHNICAL FIELD

Embodiments of the present disclosure relate to the field of computers, and more specifically, to a method, an electronic device, and a computer program product for asynchronously accessing data.

### BACKGROUND

A persistent memory technology is more and more important in a modern storage system. For example, a next generation of storage will use a persistent memory to replace a traditional nonvolatile random access memory (NVRAM). The persistent memory is applied to a direct access (DAX) mode in most cases due to its performance and programing convenience. However, in the DAX mode, there is no asynchronous method for an application program to access a persistent memory. Meanwhile, many storage applications require an asynchronous access method indeed. The lack of an asynchronous interface brings a technical challenge to applying a persistent memory to a general storage system, particularly to a data protection system.

### SUMMARY OF THE INVENTION

Embodiments of the present disclosure provide a solution for asynchronously accessing data.

In a first aspect of the present disclosure, a method for asynchronously accessing data is provided. The method may include determining, on the basis of an instruction of a user, data to be moved in a persistent memory and metadata associated with the data. The method may further include sending the metadata to a programmable network device associated with the persistent memory such that the programmable network device moves the data on the basis of the metadata. In addition, the method may include informing, in response to receiving a confirmation of operation completion from the programmable network device, the user that the operation of moving the data has been completed.

In a second aspect of the present disclosure, an electronic device is provided, which includes a processor; and a memory coupled to the processor and having instructions stored therein, wherein the instructions, when executed by the processor, cause the electronic device to perform actions including: determining, on the basis of an instruction of a user, data to be moved in a persistent memory and metadata associated with the data; sending the metadata to a programmable network device associated with the persistent memory such that the programmable network device moves the data on the basis of the metadata; and informing, in response to receiving a confirmation of operation completion from the programmable network device, the user that the operation of moving the data has been completed.

In a third aspect of the present disclosure, a computer program product is provided. The computer program product is tangibly stored on a computer-readable medium and includes machine-executable instructions, and the machine-executable instructions, when executed, cause a machine to execute any step of the method according to the first aspect.

The Summary of the Invention part is provided to introduce the selection of concepts in a simplified form, which will be further described in the Detailed Description below. The Summary of the Invention part is neither intended to identify key features or main features of the present disclosure, nor intended to limit the scope of the present disclosure.

### BRIEF DESCRIPTION OF THE DRAWINGS

Example embodiments of the present disclosure are described in more detail with reference to the accompanying drawings, the above and other objectives, features, and advantages of the present disclosure will become more apparent, and identical or similar reference numbers generally represent identical or similar components in the example embodiments of the present disclosure. In the drawings:

FIG. 1 illustrates a schematic diagram of an example environment according to an embodiment of the present disclosure;

FIG. 2 illustrates a flow chart of a process for asynchronously accessing data according to an embodiment of the present disclosure;

FIG. 3 illustrates a flow chart of a process of moving data by means of a programmable network device according to an embodiment of the present disclosure;

FIG. 4 illustrates a schematic diagram of a scenario of moving data by means of a programmable network device according to an embodiment of the present disclosure;

FIG. 5 illustrates a flow chart of another process of moving data by means of a programmable network device according to an embodiment of the present disclosure;

FIG. 6 illustrates a schematic diagram of another scenario of moving data by means of a programmable network device according to an embodiment of the present disclosure; and

FIG. 7 illustrates a block diagram of an example device that may be configured to implement embodiments of the present disclosure.

### DETAILED DESCRIPTION OF THE INVENTION

The principles of the present disclosure will be described below with reference to several example embodiments illustrated in the accompanying drawings.

As used herein, the term “include” and variations thereof mean open-ended inclusion, that is, “including but not limited to.” Unless specifically stated, the term “or” means “and/or.” The term “based on” means “based at least in part on.” The terms “an example embodiment” and “an embodiment” indicate “a group of example embodiments.” The term “another embodiment” indicates “a group of other embodiments.” The terms “first,” “second,” and the like may refer to different or identical objects. Other explicit and implicit definitions may also be included below.

As mentioned above, a DAX mode is the most recommended way to use a persistent memory. In this mode, an application is applied to map a persistent memory to a user address space of the persistent memory as a series of byte addressable spaces, and the persistent memory is accessed like a general dynamic random access memory (DRAM) through a LOAD/STORE instruction or memcpy/memmove in a C library. The DAX mode can provide the best performance since it provides direct access to the persistent memory from a user space, which completely avoids using a page cache mechanism of a traditional storage application programming interface (API).

One of the most common cases of use of the persistent memory in a storage system is to replace a traditional NVRAM, particularly for a data protection system. Due to an architectural design of a data processing pipeline, the data protection system needs to access the NVRAM in an asynchronous manner. However, there is no inherent asynchronous method to access the persistent memory in the DAX mode. Input/output (I/O) interfaces of all the existing persistent memories in the DAX are synchronous interfaces, such as memcpy( ) in C or pmem_memcpy( ) in PMDK.

The traditional ways to solve the above problems include at least the following: 1) Forging an asynchronous interface with a synchronous interface. This is relatively easy. For example, when an application sends an I/O request, the I/O request is executed through a synchronous method and then returned. When the application checks the completion status of a previous I/O request, it always replies “Completed.” However, the shortcoming of this way is that it is still inherently synchronous. The application will be blocked as it is using a synchronous interface. 2) Changing a code or even an architecture of the application to stop using an asynchronous interface. However, it is very difficult and risky to implement this way.

In order to solve, at least in part, the above problems, an embodiment of the present disclosure provides a novel solution for asynchronously accessing data. First, a computing device may determine data to be moved and metadata thereof in a persistent memory from an instruction of a user. Thus, the metadata may be sent to a preset programmable network device such that the programmable network device moves, on the basis of the metadata, the data that the user intends to move. It should be understood that the programmable network device is a smart network card with a remote direct memory access (RDMA) function, and the present disclosure can utilize this technology to achieve asynchronous access to the data. When the movement of the data is completed, the programmable network device will send a confirmation of operation completion to the computing device, thereby informing the user that the operation of moving the data is completed. Through the above operations, the operation of asynchronously accessing data can be achieved, without a need for the CPU to perform data movement, reading, writing, etc., but only by allocating such work to the programmable network device, thereby saving computing resources of the CPU.

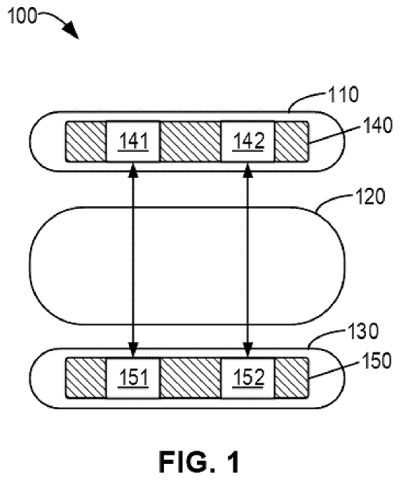

FIG. 1 shows a schematic diagram of example environment 100 according to an embodiment of the present disclosure. In this example environment 100, a device and/or a process according to embodiments of the present disclosure may be implemented. As shown in FIG. 1, example environment 100 may include user space 110, kernel space 120, and hardware 130. It should be understood that user space 110, kernel space 120, and hardware 130 are all associated with a computing device for implementing the processes of embodiments of the present disclosure, and most of the computing resources of the computing device are located in kernel space 120.

In FIG. 1, user space 110 includes application 140, and hardware 130 includes persistent memory 150. Persistent memory 150 at least includes memory blocks 151 and 152. Correspondingly, application 140 includes user address spaces 141 and 142. It should be understood that the DAS mode of the persistent memory allows application 140 to map memory blocks 151 and 152 in persistent memory 150 to user address spaces 141 and 142 in application 140, respectively, as a series of byte addressable spaces. Thus, persistent memory 150 can be accessed through a LOAD/STORE instruction or memcpy/memmove in the C library, similar to a DRAM. As shown in FIG. 1, the DAS mode of the persistent memory can provide direct access to persistent memory 150 from user space 110, which completely avoids using a page cache mechanism of a traditional storage API, thereby saving the computing resources of the CPU.

In some embodiments, the computing device herein may be any device with a computing capability. As a non-limiting example, the computing device may be any type of fixed computing device or mobile computing device, including but not limited to a desktop computer, a laptop computer, a notebook computer, a tablet computer, and the like.

It should be understood that FIG. 1 is intended only to illustrate some concepts of the present disclosure and is not intended to limit the scope of the present disclosure.

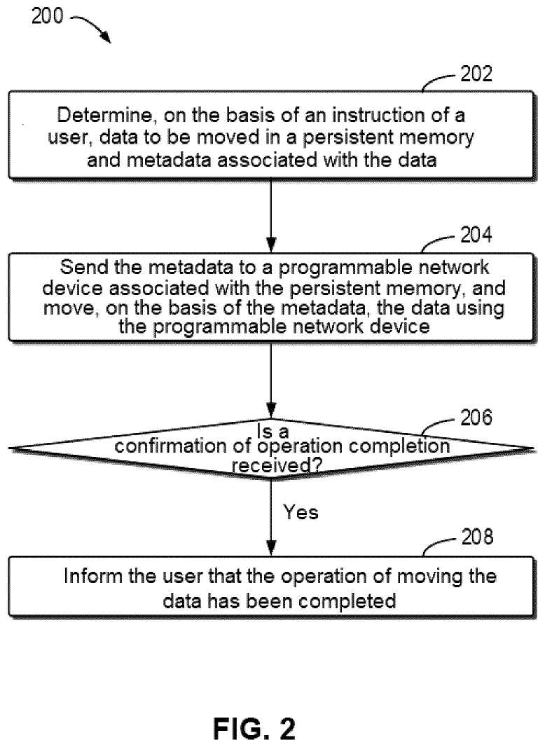

A process of asynchronously accessing data according to an embodiment of the present disclosure will be described in detail below with reference to FIG. 2. For ease of understanding, the specific data mentioned in the following description are all illustrative and are not intended to limit the scope of protection of the present disclosure. It can be understood that the embodiment described below may also include additional actions not shown and/or may omit actions as shown, and the scope of the present disclosure is not limited in this regard.

FIG. 2 illustrates a flow chart of process 200 for asynchronously accessing data according to an embodiment of the present disclosure. Process 200 for data processing according to the embodiment of the present disclosure is now described with reference to FIG. 2. For ease of understanding, specific examples mentioned in the following description are all illustrative and are not intended to limit the protection scope of the present disclosure.

As shown in FIG. 2, at 202, the computing device may determine, on the basis of an instruction of a user, data to be moved in a persistent memory and metadata associated with the data. In some embodiments, the metadata at least indicates a source position and a destination position of the data to be moved. Alternatively or additionally, the metadata at least indicates a source address, a destination address, and a data length of the data to be moved.

At 204, the computing device sends the metadata to a programmable network device associated with the persistent memory such that the programmable network device moves, on the basis of the metadata, the data that the user intends to move. In some embodiments, when being moved by the programmable network device, the data is packaged as cache data. In some embodiments, the programmable network device is implemented with a smart network card. As an example, the programmable network device may be a host channel adapter (HCA) with a RDMA function.

At 206, the computing device may detect in real time whether a confirmation of operation completion from the programmable network device is received. 208 is executed when the confirmation is received. At 208, the computing device may inform the user that the operation of moving the data is completed.

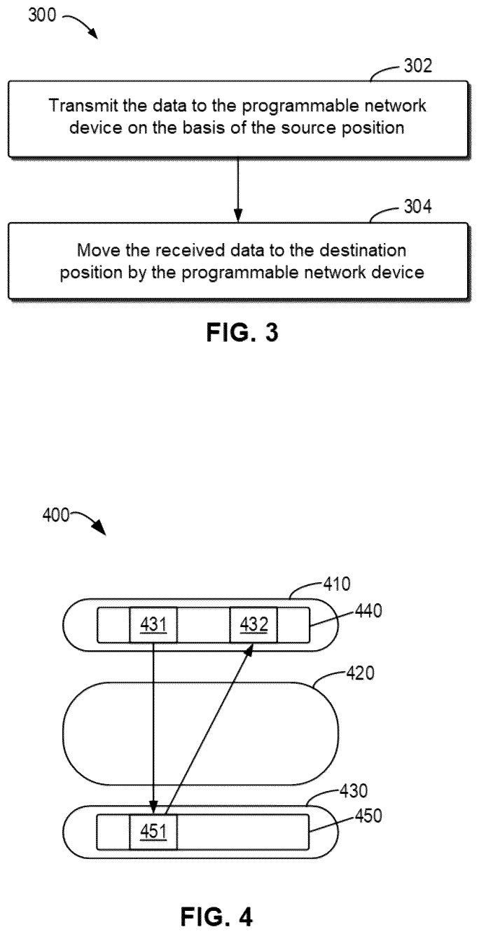

In order to describe the technical solution of the present disclosure in more detail, FIG. 3 illustrates a flow chart of process 300 of moving data by means of a programmable network device according to an embodiment of the present disclosure. Process 300 for moving data according to the embodiment of the present disclosure is now described with reference to FIG. 3. For ease of understanding, specific examples mentioned in the following description are all illustrative and are not intended to limit the protection scope of the present disclosure.

As shown in FIG. 3, in the process of utilizing the programmable network device to move the data on the basis of the metadata, at 302, the data may be transmitted to the programmable network device on the basis of the source position or source address indicated in the metadata. Thereafter, at 304, the programmable network device may move the received data to the destination position or destination address. It should be understood that the premise of the above operation is that both the source position and the destination position indicated in the metadata are located in the same persistent memory.

When the programmable network device is a smart network card or HCA with an RDMA function, RDMA connection may be established between any two separate interfaces (QP) of the smart network card according to an RDMA specification, and the two interfaces may be located on the same HCA locally. If two separate interfaces on the local HCA are picked up to establish a connection, this connection becomes a loopback between the local HCA and itself. This loopback connection may perform data transmission as shown in FIG. 4. This means that the data may be transmitted between local persistent memories through an RDMA loopback, Details of the data transmission will be described in detail below in combination with FIG. 4.

FIG. 4 illustrates a schematic diagram of scenario 400 of moving data by means of a programmable network device according to an embodiment of the present disclosure. Scenario 400 may include user space 410, kernel space 420, and hardware 430. In FIG. 4, user space 410 includes application 440, and hardware 430 includes programmable network device 450. It should be understood that application 440 in user space 410 may be mapped to a persistent memory, so the operation on application 440 in scenario 400 may be regarded as the operation on the data in the persistent memory.

Programmable network device 450 at least includes a data cache 451. Application 440 at least includes user address spaces 431 and 432. As shown in FIG. 4, user address spaces 431 and 432 are respectively used for indicating a source position and a destination position of the data that the user intends to move, and both the source position and the destination position are located in the same persistent memory. In order to move the data, the computing device may issue metadata associated with the data to programmable network device 450, so that programmable network device 450 may complete the operation of moving the data on the basis of the metadata, thereby achieving an operation of asynchronously accessing the data.

Specifically, programmable network device 450 may acquire, on the basis of the source position or source address indicated in the metadata, the data that the user intends to move from user address space 431 in application 440. In some embodiments, the data may be packaged in the form of a data cache before being transmitted to programmable network device 450, and the data will be transmitted to a specific position, such as data cache 451, in programmable network device 450. Programmable network device 450 may then move the received data to the destination position or destination address, i.e., user address space 432 in application 440 in FIG. 4. In this way, the process of moving the data does not generate an overhead in kernel space 420, thus significantly saving the computing resources of the CPU. In addition, since the main work of data transmission is completed by the computing device by triggering programmable network device 450, an asynchronous access to the persistent memory is achieved.

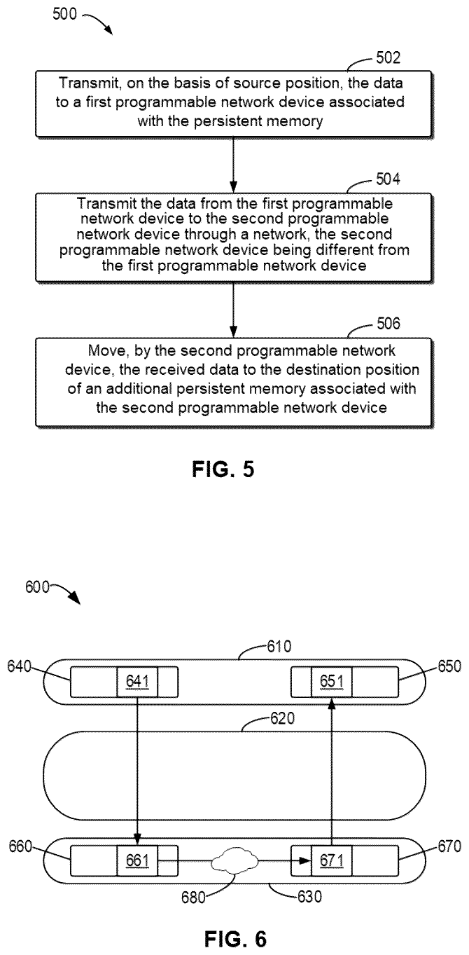

Alternatively or additionally, in order to describe the technical solution of the present disclosure in more detail, FIG. 5 illustrates a flow chart of another process 500 of moving data by means of a programmable network device according to an embodiment of the present disclosure. Process 500 for moving data according to the embodiment of the present disclosure is now described with reference to FIG. 5. For ease of understanding, specific examples mentioned in the following description are all illustrative and are not intended to limit the protection scope of the present disclosure.

As shown in FIG. 5, in the process of utilizing the programmable network device to move the data on the basis of the metadata, at 502, the data may be transmitted, on the basis of the source position or source address indicated in the metadata, to a first programmable network device associated with the persistent memory. Next, at 504, the first programmable network device transmits the data to a second programmable network device through a network, the second programmable network device being different from the first programmable network device. At last, at 506, the second programmable network device moves the received data to the destination position or destination address of an additional persistent memory associated with the second programmable network device. It should be understood that the premise of the above operation is that the source position and the destination position indicated in the metadata are located in different persistent memories, respectively.

FIG. 6 illustrates a schematic diagram of another scenario 600 of moving data by means of a programmable network device according to an embodiment of the present disclosure. Scenario 600 may include user space 610, kernel space 620, and hardware 630. In FIG. 6, user space 610 includes application 640 and application 650, and hardware 630 includes first programmable network device 660 and second programmable network device 670. It should be understood that both application 640 and application 650 in user space 610 may be mapped to persistent memories (for example, to different persistent memories, respectively), so an operation on application 640 and application 650 in scenario 600 may be regarded as an operation on the data in the persistent memories.

First programmable network device 660 may at least include data cache 661, and second programmable network device 670 may at least include data cache 671. Application 640 at least includes user address spaces 641, and application 650 at least includes user address space 651. As shown in FIG. 6, user address spaces 641 and 651 are respectively used for indicating a source position and a destination position of the data that the user intends to move, and the source position and the destination position are located in different persistent memories, respectively. In order to move the data, the computing device may issue metadata associated with the data to first programmable network device 660, so that first programmable network device 660 may acquire, on the basis of the metadata, the data that the user intends to move, from user address space 641. Thus, first programmable network device 660 may send the acquired data and the metadata of the data to second programmable network device 670 through network 680, and second programmable network device 670 may send the received data to user address space 651 on the basis of the metadata, thus achieving the operation of asynchronously accessing the data.

Specifically, first programmable network device 660 may acquire, on the basis of the source position or source address indicated in the metadata, the data that the user intends to move from user address space 641 in application 640. In some embodiments, the data may be packaged in the form of a data cache before being transmitted to first programmable network device 660, and the data will be transmitted to a specific position, such as data cache 661, in first programmable network device 660. Next, first programmable network device 660 may move the received data to a specific position, such as data cache 671, in second programmable network device 670. Thus, second programmable network device 670 may move the received data to the destination position or destination address, i.e., user address space 651 in application 650 in FIG. 6. In this way, the process of moving the data does not generate an overhead in kernel space 620, thus significantly saving the computing resources of the CPU. In addition, since the main work of data transmission is completed by the computing device by triggering first programmable network device 660 and second programmable network device 670, an asynchronous access to the persistent memory is achieved.

By means of the above-mentioned embodiments, a programmable network device with an RDMA function can be used to perform the operation of accessing the data, so that an originally synchronous persistent memory access operation can be packaged as an asynchronous access operation. In addition, since the data access operation does not occupy the kernel space, the computing resources of the CPU are saved.

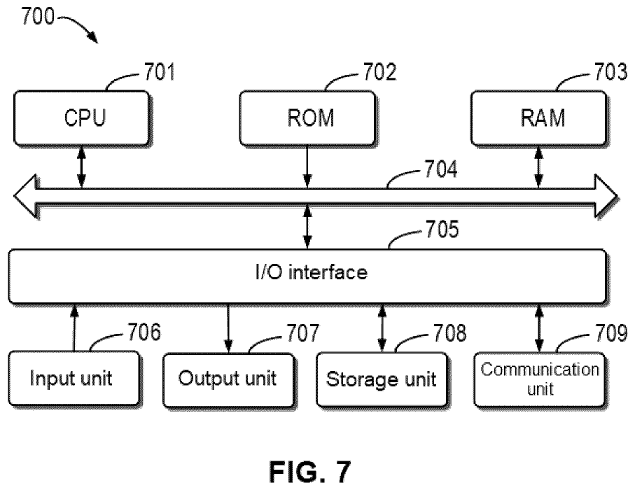

FIG. 7 illustrates a block diagram of example device 700 that may be configured to implement embodiments of the present disclosure. For example, electronic device 700 may be configured to implement computing device 221 as shown in FIG. 2. As shown in the figure, electronic device 700 includes central processing unit (CPU) 701 that may perform various appropriate actions and processing according to computer program instructions stored in read-only memory (ROM) 702 or computer program instructions loaded from storage unit 708 to random access memory (RAM) 703. Various programs and data required for the operation of device 700 may also be stored in RAM 703. CPU 701, ROM 702, and RAM 703 are connected to each other through bus 704. Input/Output (I/O) interface 705 is also connected to bus 704.

A plurality of components in device 700 are connected to I/O interface 705, including: input unit 706, such as a keyboard and a mouse; output unit 707, such as various types of displays and speakers; storage unit 708, such as a magnetic disk and an optical disc; and communication unit 709, such as a network card, a modem, and a wireless communication transceiver. Communication unit 709 allows device 700 to exchange information/data with other devices via a computer network, such as the Internet, and/or various telecommunication networks.

Processing unit 701 performs the various methods and processing described above, such as processes 300 and 400. For example, in some embodiments, the various methods and processing described above may be implemented as a computer software program or a computer program product, which is tangibly included in a machine-readable medium, such as storage unit 708. In some embodiments, part or all of the computer program may be loaded and/or installed onto device 700 via ROM 702 and/or communication unit 709. When the computer program is loaded into RAM 703 and executed by CPU 701, one or a plurality of steps of any process described above may be implemented. Alternatively, in other embodiments, CPU 701 may be configured in any other suitable manners (for example, by means of firmware) to perform a process such as processes 300 and 400.

The present disclosure may be a method, an apparatus, a system, and/or a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer-readable storage medium may be, but is not limited to, an electrical storage device, a magnetic storage device, an optical storage device, an electromagnetic storage device, a semiconductor storage device, any non-transitory storage device, or any appropriate combination of those described above. More specific examples (a non-exhaustive list) of the computer-readable storage medium include: a portable computer disk, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for executing the operation of the present disclosure may be assembly instructions, instruction set architecture (ISA) instructions, machine instructions, machine-dependent instructions, microcode, firmware instructions, status setting data, or source code or object code written in any combination of one or a plurality of programming languages, the programming languages including object-oriented programming languages such as Smalltalk and C++, and conventional procedural programming languages such as the C language or similar programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer may be connected to a user computer through any kind of networks, including a local area network (LAN) or a wide area network (WAN), or may be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

Various aspects of the present disclosure are described here with reference to flow charts and/or block diagrams of the method, the apparatus (system), and the computer program product according to the embodiments of the present disclosure. It should be understood that each block of the flow charts and/or the block diagrams and combinations of blocks in the flow charts and/or the block diagrams may be implemented by computer-readable program instructions.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing functions/actions specified in one or a plurality of blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or a plurality of blocks in the flow charts and/or block diagrams.

The computer-readable program instructions may also be loaded to a computer, a further programmable data processing apparatus, or a further device, so that a series of operating steps may be performed on the computer, the further programmable data processing apparatus, or the further device to produce a computer-implemented process, such that the instructions executed on the computer, the further programmable data processing apparatus, or the further device may implement the functions/actions specified in one or a plurality of blocks in the flow charts and/or block diagrams.

The flow charts and block diagrams in the drawings illustrate the architectures, functions, and operations of possible implementations of the systems, methods, and computer program products according to various embodiments of the present disclosure. In this regard, each block in the flow charts or block diagrams may represent a module, a program segment, or part of an instruction, the module, program segment, or part of an instruction including one or a plurality of executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in a reverse order, which depends on involved functions. It should be further noted that each block in the block diagrams and/or flow charts as well as a combination of blocks in the block diagrams and/or flow charts may be implemented by using a special hardware-based system that executes specified functions or actions, or implemented by using a combination of special hardware and computer instructions.

Various implementations of the present disclosure have been described above. The foregoing description is illustrative rather than exhaustive, and is not limited to the disclosed implementations. Numerous modifications and alterations are apparent to persons of ordinary skill in the art without departing from the scope and spirit of the illustrated implementations. The selection of terms used herein is intended to best explain the principles and practical applications of the implementations or the improvements to technologies on the market, or to enable other persons of ordinary skill in the art to understand the implementations disclosed herein.

1. A method for asynchronously accessing data, comprising:
determining, based on an instruction of a user, data to be moved in a persistent memory and metadata associated with the data;
sending the metadata to a programmable network device associated with the persistent memory such that the programmable network device moves the data on based on the metadata; and
informing, in response to receiving a confirmation of operation completion from the programmable network device, the user that the operation of moving the data has been completed.

2. The method according to claim 1, wherein the metadata at least indicates a source position and a destination position of the data.

3. The method according to claim 2, wherein the moving, by the programmable network device, the data based on the metadata comprises:
transmitting the data to the programmable network device based on the source position; and
moving, by the programmable network device, the received data to the destination position.

4. The method according to claim 3, wherein the source position and the destination position are both located in the persistent memory.

5. The method according to claim 1, wherein when being moved by the programmable network device, the data is packaged as cache data.

6. The method according to claim 2, wherein the moving, by the programmable network device, the data based on the metadata comprises:
transmitting, based on the source position, the data to a first programmable network device associated with the persistent memory;
transmitting the data from the first programmable network device to a second programmable network device through a network, the second programmable network device being different from the first programmable network device; and
moving, by the second programmable network device, the received data to the destination position of an additional persistent memory associated with the second programmable network device.

7. The method according to claim 1, wherein the programmable network device comprises a smart network card.

8. An electronic device, comprising:
a processor; and
a memory coupled to the processor and having instructions stored therein, wherein the instructions, when executed by the processor, cause the electronic device to perform actions comprising:
determining, based on an instruction of a user, data to be moved in a persistent memory and metadata associated with the data;
sending the metadata to a programmable network device associated with the persistent memory such that the programmable network device moves the data based on the metadata; and
informing, in response to receiving a confirmation of operation completion from the programmable network device, the user that the operation of moving the data has been completed.

9. The device according to claim 8, wherein the metadata at least indicates a source position and a destination position of the data.

10. The device according to claim 9, wherein the moving, by the programmable network device, the data based on the metadata comprises:
transmitting the data to the programmable network device based on the source position; and
moving, by the programmable network device, the received data to the destination position.

11. The device according to claim 10, wherein the source position and the destination position are both located in the persistent memory.

12. The device according to claim 8, wherein when being moved by the programmable network device, the data is packaged as cache data.

13. The device according to claim 9, wherein the moving, by the programmable network device, the data based on the metadata comprises:
transmitting, based on the source position, the data to a first programmable network device associated with the persistent memory;
transmitting the data from the first programmable network device to a second programmable network device through a network, the second programmable network device being different from the first programmable network device; and
moving, by the second programmable network device, the received data to the destination position of an additional persistent memory associated with the second programmable network device.

14. The device according to claim 8, wherein the programmable network device comprises a smart network card.

15. A computer program product that is tangibly stored on a computer-readable medium and comprises machine-executable instructions, wherein the machine-executable instructions, when executed, cause a machine to perform actions comprising:
determining, based on an instruction of a user, data to be moved in a persistent memory and metadata associated with the data;
sending the metadata to a programmable network device associated with the persistent memory such that the programmable network device moves the data based on the metadata; and
informing, in response to receiving a confirmation of operation completion from the programmable network device, the user that the operation of moving the data has been completed.

16. The computer program product according to claim 15, wherein the metadata at least indicates a source position and a destination position of the data.

17. The computer program product according to claim 16, wherein the moving, by the programmable network device, the data based on the metadata comprises:
transmitting the data to the programmable network device based on the source position; and
moving, by the programmable network device, the received data to the destination position.

18. The computer program product according to claim 17, wherein the source position and the destination position are both located in the persistent memory.

19. The computer program product according to claim 15, wherein when being moved by the programmable network device, the data is packaged as cache data.

20. The computer program product according to claim 16, wherein the moving, by the programmable network device, the data based on the metadata comprises:
transmitting, based on the source position, the data to a first programmable network device associated with the persistent memory;
transmitting the data from the first programmable network device to a second programmable network device through a network, the second programmable network device being different from the first programmable network device; and
moving, by the second programmable network device, the received data to the destination position of an additional persistent memory associated with the second programmable network device.
